(19) United States
(12) Patent Application Publication
(10) Pub. No.: US 2024/0325950 A1
(43) Pub. Date: Oct. 3, 2024

(54) Edible Oil Filtration Method

(71) Applicants: William E. Trent, III, Raleigh, NC (US); Mounib Aoun, Raleigh, NC (US)

(72) Inventors: William E. Trent, III, Raleigh, NC (US); Mounib Aoun, Raleigh, NC (US)

(21) Appl. No.: 18/127,126

(22) Filed: Mar. 28, 2023

(51) Int. Cl. B01D 37/02; A23D 9/04; A47J 37/12; C11B 3/00

(52) U.S. Cl. CPC B01D 37/02; A23D 9/04; A47J 37/1223; C11B 3/008

(57) ABSTRACT

A method for treating edible cooking oil which significantly expands the life of the edible cooking oil used to deep fry, wherein a rested combination of diatomaceous earth and anhydrous magnesium silicate are used as a frying and filtering aid.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to the treatment of edible oils such as cooking oils, and the like. In particular, it relates to filtering conditions for use in filtering edible oil that significantly extends the useful life of the edible oil over prior filtration methods.

### Description of Related Art

The use of fryers in restaurants for cooking a wide variety of foods extends from fast food type restaurants to upscale restaurants and everything in between. Frying is fast, easy, and most people find the taste of fried food pleasant. Many community fairs and restaurants pride themselves on the wide variety of fried foods they serve.

In the frying of foods, large amounts of edible cooking oils are heated in cookers (fryers) to temperatures in a range of about 350° F. to about 375° F. The food is usually completely immersed in the hot oil fryer until the food is cooked and usually a golden color is achieved on the outside of the food. Some oil is absorbed by the cooked food with each use and normally there is an additional amount of oil that needs to be added each day to keep the cooker full of cooking oil. The addition of oil is only done to fill up the fryer to the recommended level so it will be able to operate properly. This normally translates into about a 10-20% addition of oil each day. Because of the high temperatures and continued use of the oils, free fatty acids (FFA) are formed and the oil begins to discolor. Free fatty acids (FFA) impart an off taste to food and darker oils can discolor the food they are cooking, leading to a substandard look and taste of the food product.

If nothing is done to treat the oil, it needs to be totally replaced in as little as 3 days, which is very expensive. Depending on the usage, the oil may need to be replaced daily. Filtration of the oil on a regular basis (once a day or more) has been used for decades to remove particulate matter and does add an additional day or so to the life of the oil. However, filtering does not improve total polar materials (TPM), an indicator for extending the usable life of oil for long term usability. Other approaches to extend the life of oil are used and known. They include filtration aids that are added to the oil during filtration, and life extenders added to the oil during the filtering process. Filtration aids are normally added to the edible cooking oil at the end of the day and filtering normally starts right away after the addition of filtering aids added to the oil or filtering machine and lasts 10-15 minutes. Still, even with the known treatments, only a few more days are added to the life of the oil before the oil must be changed. Each day of extended life, however, can add up to millions of dollars overall in savings to the restaurant market. Large fast food chains spend tens of millions of dollars each year on edible cooking oil and any improvement in oil life translates into enormous dollar savings.

### BRIEF SUMMARY OF THE INVENTION

The present invention relates to the discovery of a method that extends the life of edible cooking oil when using an edible oil filtration aid, which results in an extension of oil life by at least about 50% compared with the normal process of adding a filtration aid to the edible cooking oil and immediately filtering. The method involves adding the filtration aid and allowing the oil to rest with the filtration aid before filtration, resulting in a 50% or more increase in oil life and a reduction of the filtration time by about 50% or more.

Accordingly, in one embodiment, there is a filtration method for treating an edible cooking oil to reduce Total Polar Materials and to extend the life of the edible cooking oil comprising:
a) adding the filtration aid to the edible cooking oil;
b) letting the edible cooking oil with the added filtration aid to cycle for a period of at least about 15 minutes after adding the filtration aid; and
c) filtering the edible cooking oil and returning the filtered edible cooking oil to a fryer.

In one embodiment, the oil is filtered for particulate matter prior to the addition of the filtering aid.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals, if any, are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures, if any, are for the purpose of illustrating certain convenient embodiments of the present invention, and are not to be considered as limitation thereto. The term “means” preceding a present participle of an operation indicates a desired function for which there are one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “edible cooking oil” refers to those oils that are normally used and approved for the frying of foods especially in a fryer, wherein food is immersed in the oil. Examples of cooking oils include vegetable cooking oils such as palm, corn, soybean, sunflower, canola, and the like and oils of animal origin such as lard, duck fat, fish oil, and the like. It is anticipated that the oils used herein are designed for repeated use and not for single use frying.

As used herein, the term “extend the life” refers to the method of the present invention being used in order to extend the time period before the cooking oil needs to be drained from the fryer and thrown away. Normally, complete oil replacement is from about 3 days to about 2 weeks without the method described in U.S. Pat. No. 10,974,180, but with the present method, it is at least 50% more than without the rest. Normally, [symbol] is measured as an indicator for oil life and a lowering indicates successful treatment.

As used herein, the term “edible diatomaceous earth” refers to the fossilized remains of diatoms, a type of hard-shelled algae. It is ground into a form that is approved by the FDA for consumption. The typical chemical composition is 60% to 90% silicon, 2% to 4% alumina, and 0.5% to 2% iron oxide.

As used herein, the term “edible anhydrous magnesium silicate” refers to anhydrous magnesium silicate which has been powdered and treated such that it is approved by the FDA for consumption.

One embodiment of the filtration aid refers to a composition (such as DURAFRY®) comprising or consisting essentially of 5 to 95 parts edible diatomaceous earth and 5 to 95 parts edible anhydrous magnesium silicate in parts by weight. In one embodiment, they are both 25 to 75 parts each, and in another embodiment, they are 40 to 60 parts each. In another embodiment, they are about equal. In another embodiment, the composition comprises about 100 parts by weight of the two ingredients. In use, about 0.1 ounce to about 3 ounces of the composition are added to each 16 ounces of cooking oil for every 4 to about 12 hours of continuous use during filtration of the oil. The product is added to the oil and allowed to rest (not filtered i.e.) for at least about 15 minutes after particulate filtration (if any) and addition of the filtration aid. In one embodiment, the rest period is at least about 3 hours, 6 hours, or 8 hours. In yet another embodiment, it's at least about 12 hours. In another embodiment, oil is added to the edible oil after use to “top off” the oil to a pre-determined amount.

Filtration aids include DURAFRY® (Edible Magnesium Silicate and Edible Diatomaceous Earth). Inventor adds others. Magnesol (trade name), Dallas Group of America, University of Georgia patent #6,187,355.

As used herein, the term “processing agent” refers to those things which are added to the filtration aid to improve their use, rather than additional items which further improve the life extension. Examples include, but are not limited to, at least one of a filler, anti-caking agent, a flow agent, an anti-dusting agent, a dispersion agent, a wetting agent, and an edible oil.

(recommended dosage must be used)

In using the filtration aid, the regular filtration schedule is followed, as is the topping off of the oil where needed, to keep the fryer at a predetermined level. The method involves placing the filtration aid in the edible cooking oil optionally after a particulate filtration and in one embodiment, by putting the filtration aid in the fryer. This is normally done at the end of the day when the fryers will be turned off. Instead of filtering right away, the edible cooking oil with the added filtration aid is allowed to rest, and in one embodiment, it is allowed to rest for about 6 to 12 hours. The edible oil with filtration aid is then filtered in the normal way and returned to the fryer. The filtration process time is reduced by as much as 50% using the present method.

### Example 1 (Formatting)

A filtration aid was formulated using 50% Edible Magnesium Silicate and 50% Edible Diatomaceous Earth.

### Example 2

The following test was done with the filtration aid of Example 1.

In this example, a chicken restaurant that fries chicken in hydrogenated soybean oil in a 30-pound commercial fryer at a temperature of approximately 350° F. is utilized. The fry oil is normally completely changed every 1-2 days and is unusable after that period of time. The first batch of fry oil was, in this example, treated with the filtration aid and filtered immediately. In a second batch, the fry oil was allowed to rest for about 6 hours with the filtration aid and then filtered. The oil was topped off as needed. The method using the 6-hour rest period lasted 50% more than the non-rested oil, based on TPM readings via Testo Instruments model 270.

During the testing, the food (chicken) was visually inspected for color, specifically focusing on any discoloration (darkening) browning, or caramelization of the skin, as well as TPM.

Tests were also performed on the oil during the frying phase period and tested for Free Fatty Acids (FFA) Foaming and TPM, using the titratable soap methodology, and photometric color transmission.

The overall appearance, oil reduction, FFA, color transmittance, TPM levels and foaming were shown to achieve superior results lower TPM levels over similar frying oil aids and methods currently being used in the market, specifically related to length of time in use.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A filtration method for treating an edible cooking oil to reduce Total Polar Materials and to extend the life of the edible cooking oil comprising:
a) adding the filtration aid to the edible cooking oil;
b) letting the edible cooking oil with the added filtration aid to rest for a period of at least about 15 minutes after adding the filtration aid before filtering the oil with filtration aid; and
c) filtering the edible cooking oil and returning the filtered edible cooking oil to a fryer.

2. The filtration method according to claim 1, wherein the filtration aid in parts by weight is:
a) edible diatomaceous earth, 5 to 95 parts; and
b) edible anhydrous magnesium silicate, 5 to 95 parts.

3. The filtration method according to claim 2, wherein the filtration aid consists essentially of diatomaceous earth and magnesium silicate.

4. The filtration method according to claim 2, wherein the filtration aid totals about 100 parts.

5. The filtration method according to claim 2, which further comprises a processing agent.

6. The filtration method according to claim 5, wherein the processing agent comprises at least one of an anti-caking agent, a filler, a flow agent, an anti-dusting agent, a dispersion agent, a wetting agent, and an edible oil.

7. The filtration method according to claim 6, wherein the processing agent comprises at least one of an anti-caking agent, a filler, a flow agent, an anti-dusting agent, a dispersion agent, a wetting agent, and an edible oil.

8. The filtration method according to claim 1, wherein the edible diatomaceous earth is 25 to 75 parts and the edible anhydrous magnesium silicate is 25 to 75 parts.

9. The [symbol] claim 1 where the rest period is at least about 6 hours.

10. The [symbol] claim 1 where the rest period is at least about 3 hours.
